(19) United States
(12) Patent Application Publication
(10) Pub. No.: US 2012/0098874 A1
(43) Pub. Date: Apr. 26, 2012

(54) PIXEL CIRCUIT, DRIVING METHOD THEREOF, ELECTRO-OPTICAL APPARATUS AND ELECTRONIC DEVICE

(75) Inventor: Takehiko KUBOTA, Matsumoto-shi (JP)

(73) Assignee: SEIKO EPSON CORPORATION, Tokyo (JP)

(21) Appl. No.: 13/267,284

(22) Filed: Oct. 6, 2011

(30) Foreign Application Priority Data
Oct. 25, 2010 (JP) 2010-238532

(51) Int. Cl. G09G 5/10; H05B 37/02

(52) U.S. Cl. 345/690; 315/228

(57) ABSTRACT

A pixel circuit includes a first light emitting element having a first opposite electrode connected to a first power line, a common electrode and a parasitic capacitance C1; and a second light emitting element having a second opposite electrode connected to a second power line, a common electrode and a parasitic capacitance C2. A first power potential is supplied to the first power line, and a second power potential is supplied to the second power line. The first and second power potentials change by increasing with a constant gradient from a low first potential to a high second potential in turns, and the first and second light emitting elements emit light in turns by flowing current from the parasitic capacitance C1 or C2 to the other light emitting element.

### BACKGROUND

1. Technical Field

The present invention relates to a pixel circuit having a light emitting element such as an organic EL (Electroluminescence) element, a driving method thereof, an electro-optical apparatus, and an electronic device.

2. Related Art

Recently, demand for two-screen display devices displaying two different images in right and left portions and 3D display devices outputting a right eye image and a left eye image together for 3D displaying has increased along with the propagation of car navigation systems, 3D TVs with a two-screen displaying function, and the like.

Generally, a two-screen display device arranges pixels for displaying a right image and pixels for displaying a left image in turns to optically divide right and left images by an optic device corresponding to pixels such as a lenticular lens or a parallax barrier between pixels and an observer so that different images are displayed in the right and left portions.

In addition, there is also a need to apply an organic EL element (hereinafter, referred to as an “OLED device”), a self-light emitting element, to a two-screen display device for the miniaturization of the device and to apply an HMD (Head Mounted Display).

JP-A-2006-259192 and JP-A-2009-211035 are examples of the related art.

In this two-screen display device, the number of pixels required for displaying right and left images together is generally two times that of a general one-screen display device.

In order to realize two-screen display without deteriorating the detail of display in comparison to a general one-screen display device, it is necessary to arrange pixels with a double density, which causes the increase of a product price due to complicated production processes or the deterioration of yield.

In addition, in the case where the time that a current flows in an organic EL element is limited to one horizontal scanning time, the organic EL element is required to emit light with a higher brightness in comparison to the case where the time that a current flows is one vertical scanning period. For this reason, it is necessary to flow a large current in the organic EL element. In the case where a large current flows in the organic EL element, the life of the organic EL element is shortened.

### SUMMARY

An advantage of some aspects of the invention is that a high precision two-screen display device is provided with a simple and easy configuration.

A pixel circuit according to an aspect of the invention includes a switching element having one terminal supplied with a writing voltage and the other terminal electrically connected to a node so that the switching element turns on in a writing period and turns off in a light emitting period; a first light emitting element having one electrode electrically connected to the node and the other electrode electrically connected to a first power line; a second light emitting element having one electrode electrically connected to the node and the other electrode electrically connected to a second power line; a first capacitor installed in parallel with the first light emitting element; and a second capacitor installed in parallel with the second light emitting element, wherein, in the writing period, a writing voltage is applied to the first capacitor and the second capacitor to accumulate charge, and wherein, in the light emitting period, current flows from any one of the first capacitor and the second capacitor to the light emitting element installed in parallel with the other capacitor so that the corresponding light emitting element emits light by the corresponding current.

According to the aspect of the invention, in the writing period, a writing voltage may be written in the first capacitor and the second capacitor. In addition, since the first capacitor and the second capacitor are respectively connected to the first power line and the second power line, in the light emitting period, current may flow from one capacitor to the light emitting element installed in parallel to the other capacitor by controlling the potential. By doing so, the corresponding light emitting element may emit light.

In the above pixel circuit, the first capacitor is preferably partially or entirely has a parasitic capacitance of the first light emitting element, and the second capacitor preferably partially or entirely has a parasitic capacitance of the second light emitting element. In this case, since the first capacitor and the second capacitor are configured using parasitic capacitances, the capacitive element may not be needed or its area may be reduced. As a result, the pixel circuit may be simplified, and the area of the light emitting element may be increased.

Next, according to another aspect of the invention, there is provided a method for driving a pixel circuit used for driving the above pixel circuit includes supplying a potential where a voltage applied to the first light emitting element is less than a light-emitting threshold voltage to the first power line; and supplying a potential in which a voltage applied to the second light emitting element is less than the light-emitting threshold voltage to the second power line. According to the aspect of the invention, in the writing period, the first light emitting element and the second light emitting element may not emit light, which allows display with accurate brightness,

In the above method for driving a pixel circuit, it is preferred that, in the writing period, a voltage according to brightness of the first light emitting element is written as the writing voltage, and that, in the light emitting period, a fixed potential is supplied to the first power line, and the potential of the second power line is changed to flow current from the second capacitor to the first light emitting element.

According to the aspect of the invention, the first light emitting element may emit light as the second capacitor functions as a current source of the first light emitting element. More specifically, in the light emitting period, the potential of the second power line is preferably changed to uniformly increase from the second potential to the first potential higher than the second potential so that the potential of the node increases from a potential corresponding to a writing voltage to a predetermined potential. In addition, for the predetermined potential, the potential difference between the potential of the node and the potential of the first power line is preferably equal to or greater than the light-emitting threshold voltage of the first light emitting element.

In the above method for driving a pixel circuit, it is preferred that, in the case where a voltage according to brightness of the first light emitting element is written as the writing voltage in the writing period, in the light emitting period, a fixed potential is supplied to the first power line, and the potential of the second power line is changed to flow current from the second capacitor to the first light emitting element, and that, in the case where a voltage according to brightness of the second light emitting element is written as the writing voltage in the writing period, in the light emitting period, a fixed potential is supplied to the second power line, and the potential of the first power line is changed to flow current from the first capacitor to the second light emitting element. According to the aspect of the invention, the first light emitting element and the second light emitting element may selectively emit light, which may be therefore applied to a two-screen display device or a 3D display device.

In the above method for driving a pixel circuit, it is preferred that, in the case where a voltage according to brightness of the first emitting element is written as the writing voltage in the writing period, in the light emitting period, the potentials of the first power line and the second power line are changed so that current flows from the second capacitor to the first light emitting element, and that, in the case where a voltage according to brightness of the second light emitting element is written as the writing voltage in the writing period, in the light emitting period, the potentials of the first power line and the second power line are changed so that current flows from the first capacitor to the second light emitting element.

According to the aspect of the invention, since the potentials of both of the first power line and the second power line are controlled, the current supplied to the light emitting element may be greater than the case where only one potential is controlled. In addition, in the light emitting period, by differentially changing the potential of the first power line and the potential of the second power line, the dynamic ranges of the potentials of the first power line and the second power line may be narrower, thereby ensuring easier driving.

More specifically, it is preferred that, when the second potential is lower than the first potential, in the writing period, any one potential of the first potential and the second potential is output to the first power line, the other potential of the first potential and the second potential is output to the second power line, and the writing voltage in which the potential difference between the potential of the node and the second potential is less than the light-emitting threshold voltage is supplied to the node via the switching element; and that, in the light emitting period, so that the potential of the node is changed from a potential corresponding to the writing voltage to a potential in which the potential difference between the potential of the node and the second potential corresponds to the light-emitting threshold voltage or above, the potential output to the first power line is linearly changed from any one potential of the first potential and the second potential to the other potential of the first potential and the second potential, and the potential output to the second power line is linearly changed from the one potential of the first potential and the second potential to the other potential of the first potential and the second potential.

Next, according to still another aspect of the invention, there is provided an electro-optical apparatus which includes a plurality of scanning lines, a plurality of data lines, a plurality of first power lines, and a plurality of second power lines; a pixel circuit respectively installed corresponding to intersections between the plurality of scanning lines and the plurality of data lines and having a switching element installed between the data line and a node to turn on by a selection signal, a first light emitting element having one electrode electrically connected to the node and the other electrode electrically connected to the first power line, a second light emitting element having one electrode electrically connected to the node and the other electrode electrically connected to the second power line, a first capacitor installed in parallel with the first light emitting element, and a second capacitor installed in parallel with the second light emitting element; a scanning line driving circuit for sequentially exclusively outputting the selection signal to the plurality of scanning lines; a data line driving circuit for supplying a writing voltage via the plurality of data lines to the plurality of pixel circuits installed corresponding to the scanning line selected by the selection signal; and a potential control circuit for supplying potentials to the plurality of first power lines and the plurality of second power lines, wherein, assuming that, with respect to each of the plurality of pixel circuits, a period when the selection signal is supplied is a writing period and a period when the selection signal is not supplied is a light emitting period, the potential control circuit performs: supplying a potential in which a voltage applied to the first light emitting element is less than a light-emitting threshold voltage, to the first power line connected to the pixel circuit in the writing period; supplying a potential in which a voltage applied to the second light emitting element is less than the light-emitting threshold voltage, to the second power line connected to the pixel circuit in the writing period; and setting potentials supplied to the fist power line and the second power line connected to the pixel circuit in the light emitting period so that current flows from any one of the first capacitor and the second capacitor to a light emitting element installed in parallel with the other capacitor.

According to the aspect of the invention, in the writing period, since the first light emitting element and the second light emitting element do not emit light, accurate brightness may be displayed, and further, since the first light emitting element and the second light emitting element selectively emit light, it may be applied to two-screen display devices or 3D display devices.

In addition, in the above electro-optical apparatus, by the potential control circuit, it is preferred that, with respect to the pixel circuit in which a voltage according to brightness of the first light emitting element is written as the writing voltage in the writing period, in the light emitting period, a fixed potential is supplied to the first power line corresponding to the respective pixel circuit, and the potential of the second power line corresponding to the respective pixel circuit is changed to flow current from the second capacitor to the first light emitting element, and in the case where a voltage according to brightness of the second light emitting element is written as the writing voltage in the writing period, in the light emitting period, a fixed potential is supplied to the second power line, and the potential of the first power line is changed to flow current from the first capacitor to the second light emitting element. In this case, by changing the potential of the power line connected to the light emitting element which does not emit light, current may flow to the light emitting element which emits light.

In addition, in the above electro-optical apparatus, it is preferred that, with respect to the pixel circuit in which a voltage according to brightness of the first light emitting element is written as the writing voltage in the writing period, in the light emitting period, the potentials of the first power line and the second power line corresponding to the respective pixel circuit are changed so that current flows from the second capacitor to the first light emitting element, and that, with respect to the pixel circuit in which a voltage according to brightness of the second light emitting element is written as the writing voltage in the writing period, in the light emitting period, the potentials of the first power line and the second power line corresponding to the respective pixel circuit are changed so that current flows from the first capacitor to the second light emitting element. According to the aspect of the invention, since the potentials of both of the first power line and the second power line are controlled, the current supplied to the light emitting element may be increased in comparison to the case where only one potential is controlled. In addition, in the light emitting period, by differentially changing the potential of the first power line and the potential of the second power line, the dynamic ranges of the potentials of the first power line and the second power line may be narrowed, which ensures easy driving.

Next, according to still another aspect of the invention, there is provided an electronic device including some of the above electro-optical apparatuses. The electronic device may be a two-screen display device such as a car navigation system and an HMD, or a one-screen display device such as a personal computer and a cellular phone. If this electronic device is used, even in the case of two-screen display, the images are not displayed by different electro-optical apparatuses but displayed by one electro-optical apparatus, which allows the device to have a smaller and lighter design.

### BRIEF DESCRIPTION OF THE DRAWINGS

The invention will be described with reference to the accompanying drawings, wherein like numbers reference like elements.

FIG. 1 is a block diagram showing a display device according to an embodiment of the invention.

FIG. 2 is a circuit view showing a pixel circuit.

FIG. 3 is a timing chart showing operations of the display device.

FIGS. 4A and 4B are timing charts showing operations of the display device.

FIGS. 5A and 5B are timing charts showing operations of the display device.

FIGS. 6A to 6C are diagrams showing a state of the pixel circuit at each period.

FIG. 7 is a block diagram showing the arrangement of a negative electrode of the display device.

FIGS. 8A and 8B are sectional views showing the configuration of the display device.

FIG. 9 is a timing chart showing operations of a display device according to a second embodiment of the invention.

FIGS. 10A and 10B are diagrams showing a light emitting pattern of the display device according to the second embodiment of the invention.

FIGS. 11A and 11B are sectional views showing the display device according to the second embodiment of the invention in the case where a parallax barrier or a lenticular lens is applied to the display device.

FIG. 12 is a timing chart showing operations of a display device according to a third embodiment of the invention.

FIGS. 13A and 13B are timing charts showing operations of the display device according to the third embodiment of the invention.

FIGS. 14A and 14B are diagrams showing a state of a pixel circuit at each period according to the third embodiment of the invention.

FIGS. 15A and 15B are diagrams showing a state of the pixel circuit at each period according to the third embodiment of the invention.

FIG. 16 is a block diagram showing the arrangement of a negative electrode of a display device according to a modified example of the invention.

FIG. 17 is a plane view showing the configuration of a HMD (Head Mounted Display).

FIG. 18 is a perspective view showing an electronic device (a personal computer).

FIG. 19 is a perspective view showing an electronic device (a cellular phone).

### DESCRIPTION OF EXEMPLARY EMBODIMENTS

### A: First Embodiment

Hereinafter, various embodiments of the invention will be described with reference to the accompanying drawings. In the drawings, the dimensions and ratios of each component are suitably changed from actual ones.

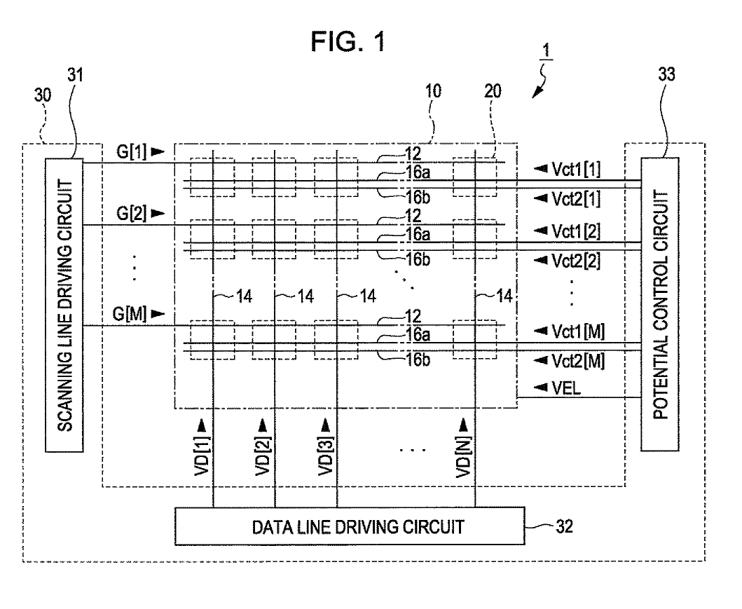

FIG. 1 is a block diagram showing a display device 1 according to the first embodiment of the invention. The display device 1 includes a display region 10 in which a plurality of pixel circuits 20 are arranged, and a driving circuit 30 for driving each pixel circuit 20. The driving circuits 30 are distributed and mounted to, for example, a plurality of integrated circuits. However, at least a part of the driving circuits 30 may be configured as a thin film transistor formed on a substrate together with the pixel circuit 20.

In the display region 10, M number of scanning lines 12 extending in an X direction, M number of first power lines 16a and M number of second power lines 16b extending in the X direction, and N number of data lines 14 extending in a Y direction crossing the X direction are formed (M and N are natural numbers of 1 or above). In addition, M number of scanning lines 12 and M number of first power lines 16a correspond to each other in a one-to-one relationship, and M number of scanning lines 12 and M number of second power lines 16b correspond to each other in a one-to-one relationship. The plurality of pixel circuits 20 correspond to the scanning lines 12 and the data lines 14 in turns and are arranged in a lattice pattern of M columns in a vertical direction and N rows in a horizontal direction.

The driving circuit 30 includes a scanning line driving circuit 31, a data line driving circuit 32 and a potential control circuit 33. The scanning line driving circuit 31 is used for sequentially selecting the plurality of pixel circuits 20 in the unit of a column, generates a selection signal G[i] (i is an integer satisfying 1≦i≦M) for sequentially selecting the plurality of pixel circuits 20 in the unit of a column, and outputs the selection signal G[i] to each scanning line 12.

The data line driving circuit 32 outputs a data potential VD[j] according to a tone (hereinafter, referred to as a “designated tone”) by which a light emitting element of each pixel circuit 20 should emit light, to the j^{th} row data line 14, when j is an integer satisfying 1≦i≦N. In addition, the pixel circuit 20 in a j row has M number of circuits from the first column to the M^{th} column. For this reason, in the following description, the potential supplied to the j^{th} row data line 14 is written as a data potential VD[j], and the potential supplied to the pixel circuit 20 in an i column and a j row is written as a data potential VD[i, j].

The potential control circuit 33 generates a first power potential Vct1[i] and outputs it to each first power line 16a, and also generates a second power potential Vct2[i] and outputs it to each second power line 16b.

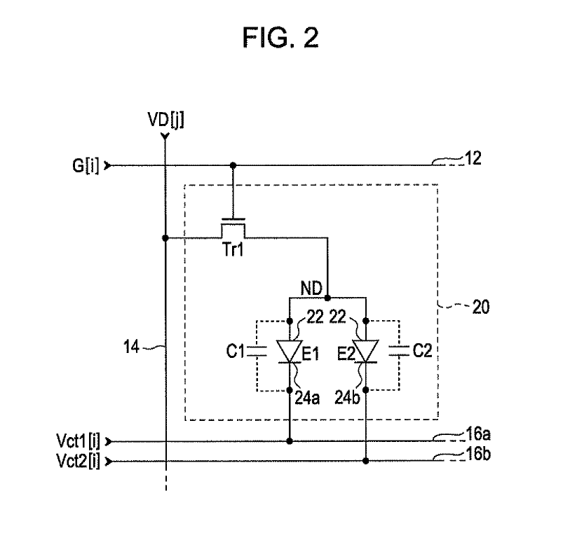

FIG. 2 is a circuit diagram of the pixel circuit 20. The pixel circuit 20 in the i column and the j row is representatively shown in FIG. 2.

The pixel circuit 20 includes a selection transistor Tr1, a first light emitting element E1, and a second light emitting element E2. The gate of the selection transistor Tr1 is connected to the scanning line 12 in the i column. Any one of the source and drain of the selection transistor Tr1 is connected to the j^{th} row data line 14, and the other of the source and drain of the selection transistor Tr1 is connected to a node ND. In the first embodiment, the selection transistor Tr1 has n channels.

If the selection signal G[i] supplied to the scanning line 12 of the i column comes to be a high level, the selection transistor Tr1 turns on, and the data line 14 and the node ND are electrically connected. Meanwhile, in the period when the selection signal G[i] is at a low level, the selection transistor Tr1 turns off, and the data line 14 and the first node ND are not connected.

The first light emitting element E1 and the second light emitting element E2 may be configured as light emitting diodes. In this example, an organic EL element having a light-emitting layer made of organic EL (Electroluminescence) material and interposed between a positive electrode and a negative electrode is used.

The first light emitting element E1 uses a common electrode 22 electrically connected to the node ND as a positive electrode and uses a first opposite electrode 24a electrically connected to the first power line 16a as a negative electrode. The second light emitting element E2 uses the common electrode 22 as a positive electrode and uses a second opposite electrode 24b electrically connected to the second power line 16b as a negative electrode. The first opposite electrode 24a is electrically connected to the potential control circuit 33 via the first power line 16a, and the second opposite electrode 24b is electrically connected to the potential control circuit 33 via the second power line 16b.

The common electrode 22 functions as a common positive electrode of the first light emitting element E1 and the second light emitting element E2. A parasitic capacitance C1 is incidental to the first light emitting element E1 in parallel, and a parasitic capacitance C2 is incidental to the second light emitting element E2 in parallel.

In the first light emitting element E1 and the second light emitting element E2, if a voltage of a light-emitting threshold voltage Vth or above is applied between the positive electrode and the negative electrode, a current flows in the light-emitting layer from the positive electrode to the negative electrode. The light-emitting layer emits light with brightness according to the intensity of the current.

In addition, in the first embodiment, only the first light emitting element E1 emits light with brightness according to the data potential VD[j], and the second light emitting element E2 does not emit light. In the second light emitting element E2 of this embodiment charge according to the data potential is supplied to the parasitic capacitance C2.

In addition, though the first embodiment uses the common electrode 22 as a positive electrode and uses the first opposite electrode 24a and the second opposite electrode 24b as negative electrodes, it is also possible that the common electrode 22 is used as a negative electrode and the first opposite electrode 24a and the second opposite electrode 24b are used as positive electrodes, without being limited to the above.

Moreover, though the first embodiment uses the common electrode 22 as a common positive electrode of the first light emitting element E1 and the second light emitting element E2, the positive electrode of the first light emitting element E1 and the negative electrode of the second light emitting element may be distinguishably formed, without being limited to the above.

Further, though in this embodiment the parasitic capacitance C1 is incidental to the first light emitting element E1 in parallel and the parasitic capacitance C2 is incidental to the second light emitting element E2 in parallel, the invention is not limited thereto. For example, a capacitive element may be installed in parallel with the first light emitting element E1, and a capacity element may be installed in parallel with the second light emitting element E2. In other words, the capacitors installed to the first light emitting element E1 and the second light emitting element in parallel may be parasitic capacitances, capacity elements, or a parasitic capacitance and a capacity element.

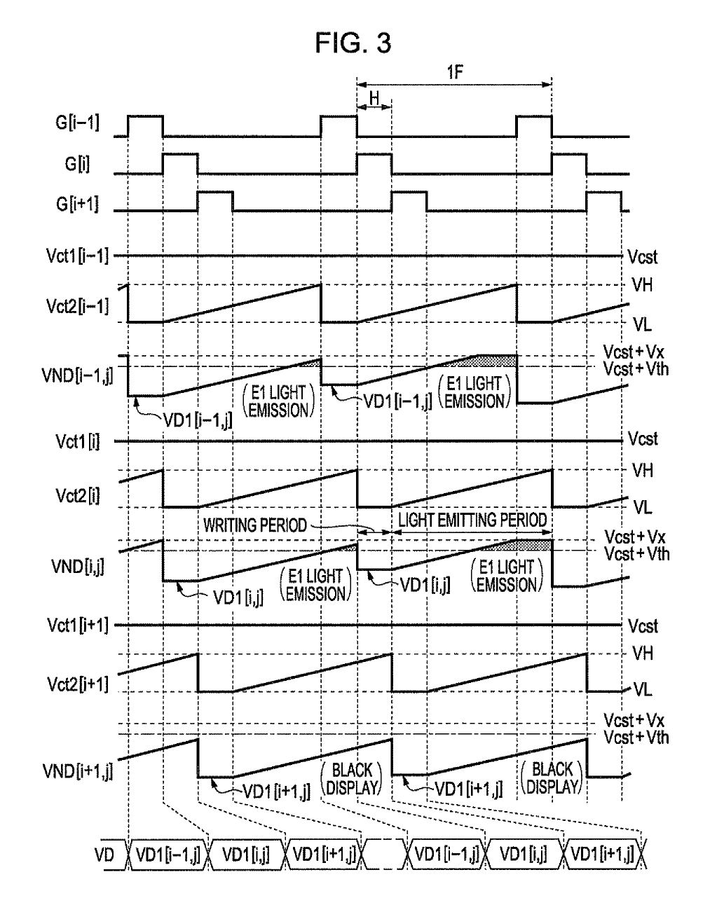

FIG. 3 is a timing chart for illustrating operations of the display device 1. As shown in FIG. 3, the selection signal G[i] is a pulse signal with a cycle corresponding to one vertical scanning period and is supplied to the scanning line 12 in the i column. The pulse width of the selection signal G[i], namely the period when the selection signal G[i] is at a high level corresponds to one horizontal scanning period. In addition, the selection signal G[i] increases to a high level later than the selection signal G[i−1] by the period corresponding to one horizontal scanning period. According to this selection signal G[1] to G[M], M number of scanning lines 12 are sequentially exclusively selected at every one horizontal scanning period.

In the period when the selection signal G[i] is at a high level, namely in the period when the scanning line 12 in the i column is selected, the data potential VD[i, 1] to VD[i, N] defining the tone of the pixel circuits 20 is supplied from the data line driving circuit 32 to N number of pixel circuits 20 in the i column.

The data potential VD[i, j] may be configured with a first data potential VD1[i, j] defining the tone of the first light emitting element E1 and a second data potential VD2[i, j] defining the tone of the second light emitting element E2 among the pixel circuits 20. However, in the first embodiment, since only the first light emitting element E1 emits light as described above, only the first data potential VD1[i, j] is supplied to each first pixel circuit 20 during the period when the selection signal G[i] is at a high level.

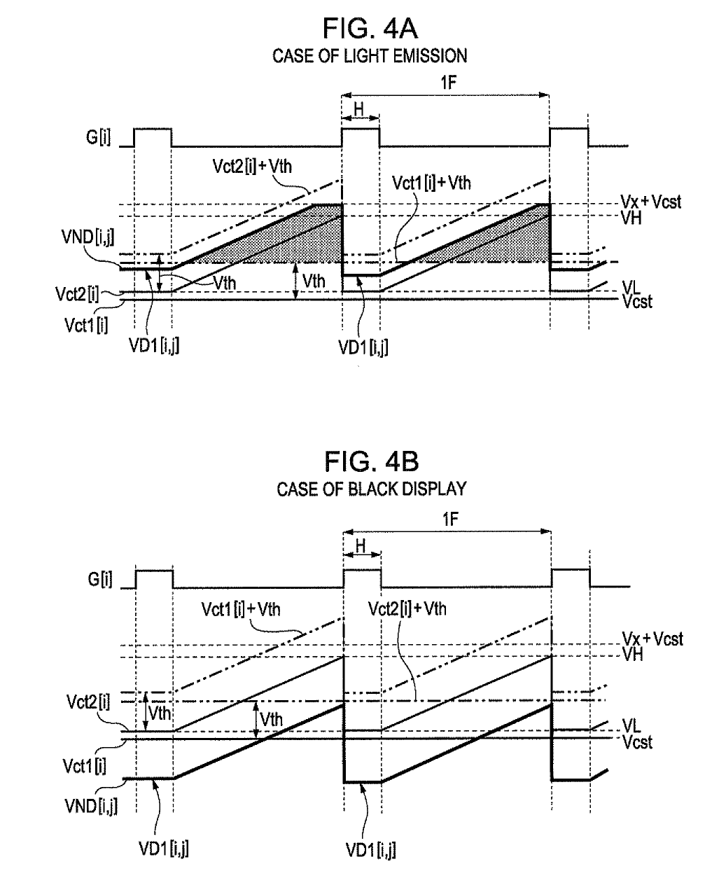

FIGS. 4A and 4B are diagrams in which the first power potential Vct1[i], the second power potential Vct2[i], the first data potential VD1[i, j], and the potential VND[i, j] of the node ND supplied to the pixel circuit 20 in the i column and the j row are plotted on the same gradations approximately in the Y-axial direction in FIG. 3. As shown in FIGS. 3, 4A and 4B, in the first embodiment, the first power potential Vct1[i] is maintained at a fixed potential Vcst. In addition, as the fixed potential Vcst, the ground potential Vgnd may be supplied, and a consistent potential other than the ground potential Vgnd may also be supplied.

The second power potential Vct2[i] is a signal having a lamp waveform with a period corresponding to one vertical scanning period. The second power potential Vct2[i] is maintained at the first potential VL in the period when the selection signal G[i] is at a high level, and linearly increases with a constant gradient from the first potential VL to the second potential VH higher than the first potential VL during the period when the selection signal G[i] is in a low period.

The potential VND[i, j] of the node ND is set to a data potential VD[i, j] supplied from the data line driving circuit 32 during the writing period when the selection signal G[i] is at a high level.

In addition, during the light emitting period when the selection signal G[i] is at a low level, the second power potential Vct2[i] increases with a constant gradient, and therefore the potential VND[i, j] of the node ND linearly increases with a constant gradient along with the second power potential Vct2[i]. This is because the parasitic capacitance C2 functions as a coupling capacity.

However, according to the voltage current characteristics of the light emitting element, if a voltage of a light-emitting threshold voltage Vth or above is applied between the positive electrode and negative electrode, current flows in the light emitting element from the positive electrode to the negative electrode, but the current capacity increases as an exponential function. In other words, the current corresponding to the applied voltage flows in the light emitting element according to the voltage current characteristics of the light emitting element, and on the contrary, the voltage corresponding to the current is generated at both ends of the light emitting element.

Here, it is assumed that the applied voltage of the light emitting element is 0 V. In this state, if the current corresponding to a light-emitting threshold voltage Vth or above is supplied to the light emitting element, the voltage of the light emitting element increases up to an operation voltage determined by the current voltage characteristics, and the voltage becomes consistent after reaching the operation voltage.

In this embodiment, the intensity of the current flowing on the first light emitting element E1 is determined as a slant of the second power potential Vct2[i]. Here, the current flowing on the first light emitting element E1 is called “I1”. In the case where the current I1 normally flows on the first light emitting element E1, the voltage (the potential difference between the negative and positive electrodes) of the first light emitting element E1 is called as an operation voltage Vx.

As shown in FIG. 4A, after reaching the potential higher than fixed potential Vcst set to the first power potential Vct1[i] by the operation voltage Vx, the potential VND[i, j] of the node ND is consistently maintained at the corresponding potential Vcst+Vx while the selection signal G[i] is at a low level.

If the potential VND[i, j] of the node ND becomes the potential higher than the first power potential Vct1[i] supplied from the first power line 16a by the light-emitting threshold voltage Vth or more, the first light emitting element E1 emits light. In addition, if the potential VND[i, j] of the node ND becomes a potential higher than the second power potential Vct2[i] supplied from the second power line 16b by the light-emitting threshold voltage Vth or more, the second light emitting element E2 emits light.

In the period when the selection signal G[i] is at a high level, the data potential VD[i, j] set by the node ND satisfies Equations (1) to (3) as follows.

VD[i,j]−VL<Vth (1)

VD[i,j]−Vcst<Vth (2)

VD[i,j]+(VH−VL)−Vcst≧Vth (3)

Equation (1) represents that the potential difference between the data potential VD[i, j] and the first potential VL is less than the light-emitting threshold voltage Vth.

In the period when the selection signal G[i] is at a high level, the potential VND[i, j] of the node ND is identical to the data potential VD[i, j], and the second power potential Vct2[i] is set as the first potential VL. Therefore, in the case where Equation (1) is satisfied, the second light emitting element E2 is not capable of emitting light during the period when the selection signal G[i] is at a high level.

In addition, in the case where Equation (1) is satisfied, the potential difference between the potential VND[i, j] of the node ND and the second power potential Vct2[i] is maintained to be less than the light-emitting threshold voltage Vth even during the period when the selection signal G[i] is at a low level, and therefore the second light emitting element E2 is not capable of emitting light over one vertical scanning period.

Equation (2) represents that the potential difference between the data potential VD[i, j] and the fixed potential Vcst is less than the light-emitting threshold voltage Vth.

In the period where the selection signal G[i] is at a high level, the potential VND[i, j] of the node ND is identical to the data potential VD[i, j], and the first power potential Vct1[i] is set to the fixed potential Vcst. Therefore, in the case where Equation (2) is satisfied, the first light emitting element E1 does not emit light in the period when the selection signal G[i] is at a high level.

Equation (3) represents that the data potential VD[i, j] becomes a potential higher than the fixed potential Vcst by the light-emitting threshold voltage Vth or more in the case where a voltage corresponding to the difference between the second potential VH and the first potential VL is added thereto.

In the period when the selection signal G[i] is at a high level, the potential VND[i, j] of the node ND is identical to the data potential VD[i, j], but in the period when the selection signal G[i] is at a low level, the second power potential Vct2[i] increases from the first potential VL to the second potential VH, and therefore the potential VND[i, j] of the node ND also increases. Meanwhile, the first power potential Vct1[i] is set to the fixed potential Vcst. Therefore, in the period when the selection signal G[i] is at a low level the first light emitting element E1 is capable of emitting light, and thus at least Equation (3) should be satisfied.

As described above, by supplying the data potential VD[i, j] to the pixel circuit 20 under the restrictions of Equations (1) to (3), in the period when the selection signal G[i] is at a low level, the first light emitting element is capable of emitting light with the brightness defined by the data potential VD[i, j], but in the period when the selection signal G[i] is at a high level, the first light emitting element E1 and the second light emitting element E2 do not emit light.

In addition, in the case where the pixel circuit 20 is set to black display, in other words in the case where the first light emitting element E1 (and the second light emitting element E2) does not emit light, the condition is that Equation (3) is not satisfied. In other words, if the data potential VD[i, j] satisfying Equation (4) as follows is supplied, the corresponding pixel circuit 20 may be able to set black display.

VD[i,j]+(VH−VL)−Vcst<Vth (4)

FIG. 4B shows the first power potential Vct1[i], the second power potential Vct2[i], the first data potential VD1[i, j], and the potential VND[i, j] of the node ND, which satisfy Equation (4).

As shown in FIG. 4B, in the case where the first data potential VD1[i, j] satisfying Equation (4) is set as the potential VND[i, j] of the node ND, the potential VND[i, j] of the node ND will not be a potential higher than the fixed potential Vcst by the light-emitting threshold voltage Vth or more over one vertical scanning period. Therefore, in this case, the first light emitting element E1 does not emit light.

In addition, in FIGS. 4A and 4B, the first potential VL, the second potential VH, and the fixed potential Vcst have a relationship satisfying Equation (5) as follows.

Vcst≦VL<VH (5)

However, the invention is not limited thereto. For example, they may satisfy Equation (6) as follows.

VL≦Vcst<VH (6)

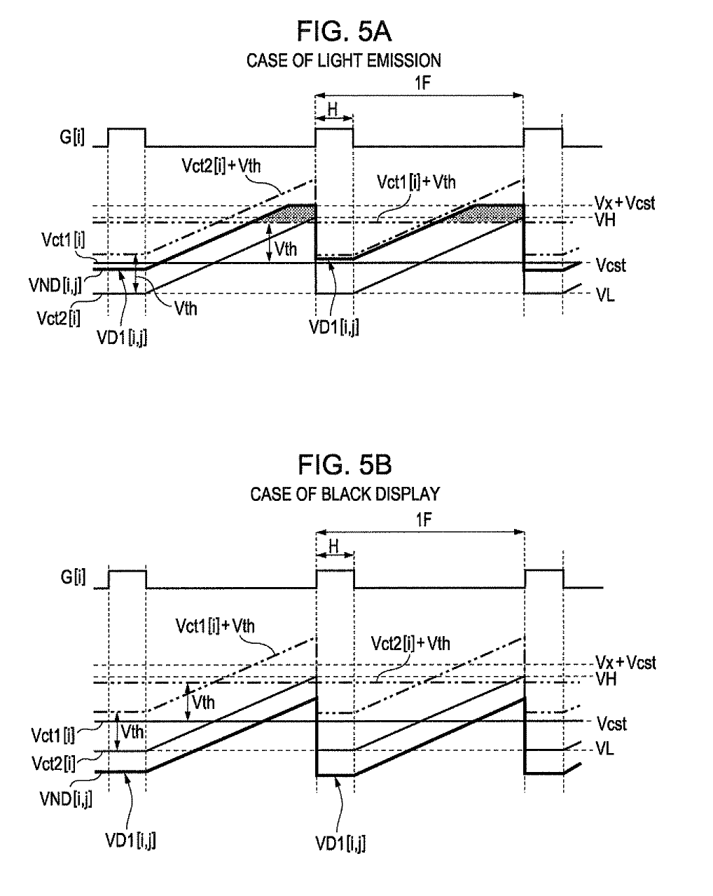

FIGS. 5A and 5B show the first power potential Vct1[i], the second power potential Vct2[i], the first data potential VD1[i, j], and the potential VND[i, j] of the node ND, which satisfy Equation (6). In addition, as shown in FIGS. 5A and 5E, in the case where Equation (6) is satisfied, the period when the first light emitting element E1 emits light is shortened rather than the case where Equation (5) shown in FIGS. 4A and 4B is satisfied. For this reason, it is preferred to satisfy Equation (5) when considering the light-emitting effects.

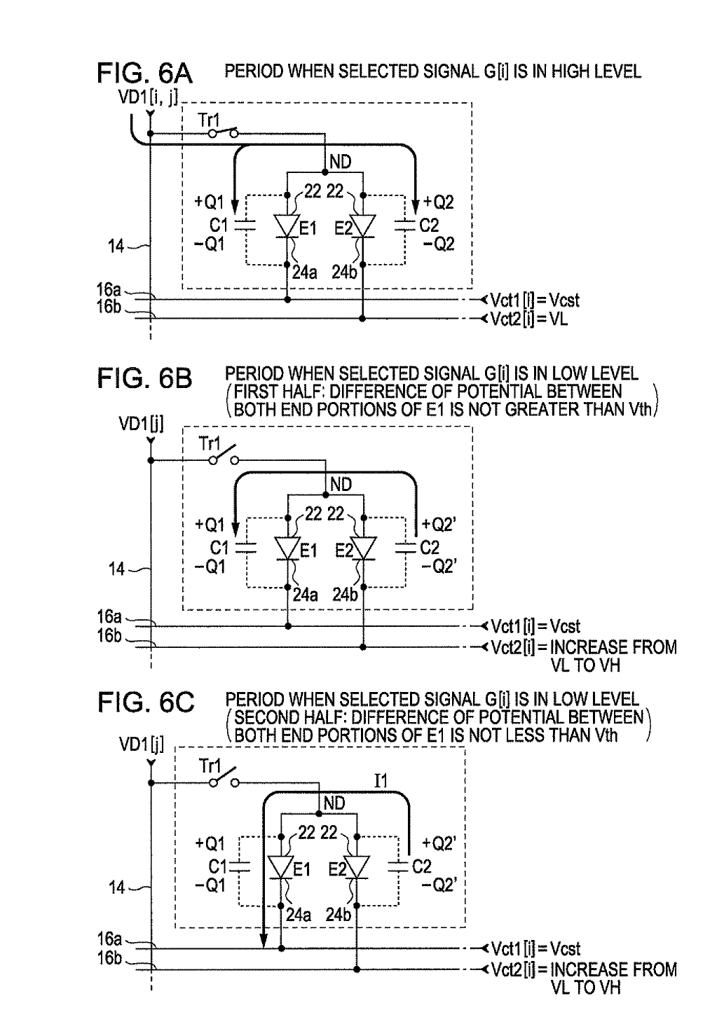

Referring to FIGS. 6A to 6C, the operations of the pixel circuit 20 in the i column and the j row will be described. FIG. 6A is a diagram showing operations of the pixel circuit 20 during the period when the selection signal G[i] is at a high level.

In the period when the selection signal G[i] is at a high level, the selection transistor Tr1 turns on. From the data line 14, the first data potential VD1[i, j] is supplied via the node ND to the parasitic capacitance C1 and the parasitic capacitance C2. By doing so, the potential VND[i, j] of the node ND is set to the first data potential VD1[i, j] so that the charge Q1 corresponding to the first data potential VD1[i, j] is supplied to the parasitic capacitance C1 and the charge Q2 corresponding to the first data potential VD1[i, j] is supplied to the parasitic capacitance C2. In addition, the first data potential VD1[i, j] is set to satisfy Equations (1) to (3).

In addition, the first power potential Vct1[i] is set to the fixed potential Vcst. In Equation (2), the potential difference between both electrodes of the first light emitting element E1 is less than the light-emitting threshold voltage Vth, and therefore the first light emitting element E1 does not emit light. In addition, the second power potential Vct2[i] is set to the first potential VL. In Equation (1), the potential difference between both electrodes of the second light emitting element E2 is less than the light-emitting threshold voltage Vth, and therefore the second light emitting element E2 does not emit light.

FIG. 6B is a diagram showing operations of the pixel circuit 20 during the period after the period of FIG. 6A, namely the period just after the selection signal G[i] decreases to a low level. In the period of FIG. 6B, the selection signal G[i] is at a low level, and therefore the selection transistor Tr1 turns off, and the data line 14 and the first node ND are not connected.

The second power potential Vct2[i] increases with a constant gradient from the first potential VL to the second potential VH. Along with this, the current flowing from the parasitic capacitance C2 toward the parasitic capacitance C1 is generated, and the potential VND[i, j] of the node ND increases. The first power potential Vct1[i] is set to the fixed potential Vcst. During the period when the potential difference VND[i]−Vcst between both electrodes of the first light emitting element E1 is less than the light-emitting threshold voltage Vth, the first light emitting element E1 does not emit light.

FIG. 6C is a diagram showing operations of the pixel circuit 20 during the period after the period of FIG. 6B, which is in the period when the selection signal G[i] is at a low level. In the period shown in FIG. 6C, the second power potential Vct2[i] increases with a constant gradient successively from the period of FIG. 6B, resulting in that the potential VND[i, j] of the node ND increases along with it and the potential difference VND[i]−Vcst between both electrodes of the first light emitting element E1 becomes greater than the light-emitting threshold voltage Vth. By doing so, the current I1 with an intensity corresponding to the first data potential VD1[i, j] flows on the first light emitting element E1 from the parasitic capacitance C2 and light with the brightness defined by the first data potential VD1[i, j] is emitted.

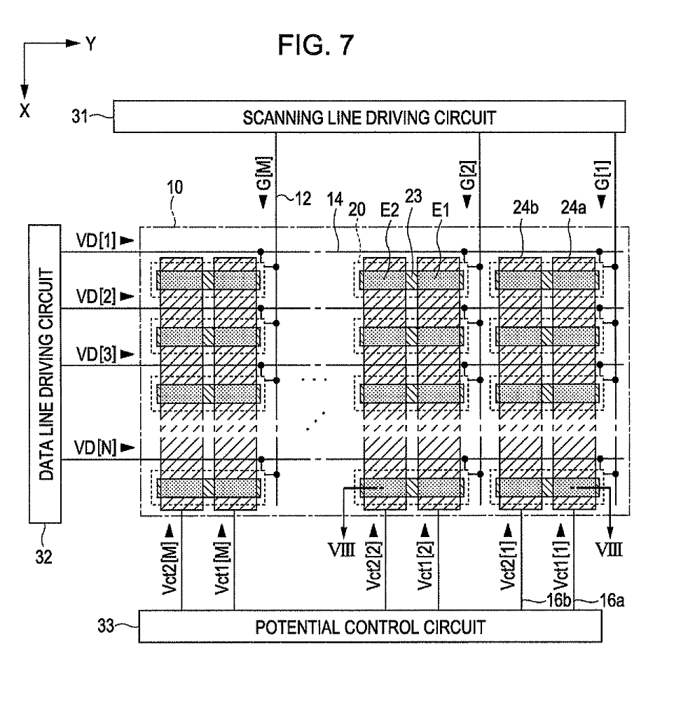

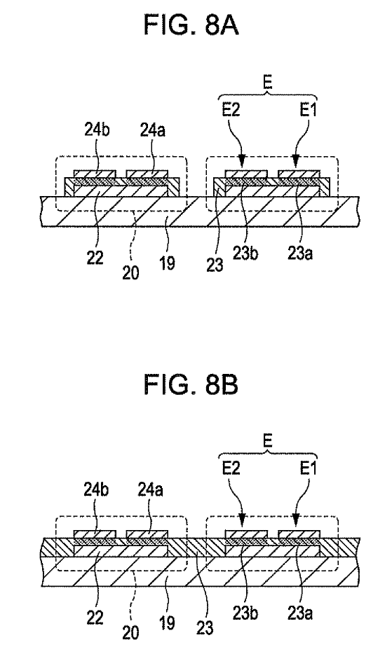

One example of the arrangement of the first opposite electrode 24a and the second opposite electrode 24b with respect to the common electrode 22, the first light emitting element E1 and the second light emitting element E2 of each pixel circuit 20 will be described with reference to FIGS. 7 to 8B.

FIG. 7 is a block diagram showing the arrangement of the first opposite electrode 24a and the second opposite electrode 24b with respect to each pixel circuit 20. As shown in FIG. 7, in each pixel circuit 20, a light emitting layer 23 having a rectangular shape with a long side parallel to the Y axis and a short side parallel to the X axis is formed.

The first opposite electrode 24a has a rectangular shape with a long side parallel to the X axis and a short side parallel to the Y axis, and is installed commonly to N number of first light emitting elements E1 respectively provided to N number of pixel circuits 20 connected to each scanning line 12. In addition, M number of first opposite electrodes 24a are formed corresponding to M number of scanning lines 12. Similarly, the second opposite electrode 24b has a rectangular shape with a long side parallel to the X axis and a short side parallel to the Y axis, and is installed commonly to N number of second light emitting elements E2 respectively provided to N number of pixel circuits 20 connected to each scanning line 12. In addition, M number of second opposite electrodes 24b are formed corresponding to M number of scanning lines 12. A pair of the first opposite electrode 24a and the second opposite electrode 24b are disposed with a certain distance to overlap the light emitting layers 23 of N number of pixel circuits 20 connected to each scanning line 12.

M number of first opposite electrodes 24a are respectively connected to the potential control circuit 33 by M number of first power lines 16a, and M number of second opposite electrodes 24b are respectively connected to the potential control circuit 33 by M number of second power lines 16b.

FIG. 8A is a sectional view showing the pixel circuit 20 of FIG. 7, taken along the line VIIIA-VIIIA. As shown in FIG. 8A, the common electrode 22 is formed on the substrate 19 in a one-to-one relationship with each pixel circuit 20, and the light emitting layer 23 is formed on the substrate 19 and the common electrode 22. On the light emitting layer 23, the first opposite electrode 24a and the second opposite electrode 24b are formed at regular intervals respectively at a location corresponding to each common electrode 22.

The first light emitting element E1 includes a first light emitting unit 23a of the light emitting layer 23 located between the first opposite electrode 24a and the common electrode 22, a first opposite electrode 24a, and a portion of the common electrode 22 contacting the first light emitting unit 23a. Similarly, the second light emitting element E2 includes a second light emitting unit 23b of the light emitting layer 23 located between the second opposite electrode 24b and the common electrode 22, a second opposite electrode 24b, and a portion of the common electrode 22 contacting the second light emitting unit 23b. In other words, in each pixel circuit 20, the first light emitting element E1 and the second light emitting element E2 are disposed to be arranged along the Y axis.

In addition, though not shown in the figures, the scanning line 12 and the data line 14 are formed on the substrate 19.

Further, though it is shown in FIGS. 7 and 8A that the light emitting layer 23 is in a one-to-one relationship with each pixel circuit 20, the invention is not limited to such arrangement.

In other words, as shown in FIG. 8B, the light emitting layer 23 may be commonly formed at a plurality of pixel circuits 20. In this case, as the light emitting layer 23 need not be arranged distinguishably at every pixel circuit 20, production processes can be simplified.

In addition, though not shown in the figures, a barrier may be formed between the first light emitting element E1 and the second light emitting element E2 to separate the first light emitting element E1 and the second light emitting element E2. In this case, it is possible to decrease the leakage of light between adjacent light emitting layers, which allows for the display of clearer images.

As described above, in the first embodiment, the first light emitting element E1 and the second light emitting element E2 are provided to the pixel circuit 20, and in order for one light emitting element to be made to emit light, the potential of the power line connected to the other light emitting element is changed so that the charge supplied to its parasitic capacitance flows on one light emitting element as current, which allows one light emitting element to emit light with a simple configuration.

In addition, in the writing period when the selection signal G[i] is at a high level, the data potential VD[j] written in the pixel circuit 20 is set be less than the light-emitting threshold voltage Vth of the first light emitting element E1 and the second light emitting element E2, and therefore the first light emitting element E1 and the second light emitting element E2 may not emit light in the writing period.

In addition, in the first embodiment, the first opposite electrode 24a and the second opposite electrode 24b are disposed so that the long side of each common electrode 22 crosses the long sides of the first opposite electrode 24a and the second opposite electrode 24b at right angles. By doing so, it is possible that the short sides of the first opposite electrode 24a and the second opposite electrode 24b become longer in comparison to the case where the first opposite electrode 24a and the second opposite electrode 24b are disposed so that the short side of each common electrode 22 crosses the long sides of the first opposite electrode 24a and the second opposite electrode 24b. Therefore, the display device 1 of the first embodiment has advantages of simplified production and improved yield.

### B: Second Embodiment

The display device according to the first embodiment is configured so that the first power potential Vct1[i] is the fixed potential Vcst and the second power potential Vct2[i] has a lamp waveform, whereby the first light emitting element E1 emits light and the second light emitting element E2 does not emit light. In contrast to this, the display device according to the second embodiment is different from the display device of the first embodiment in the points that the first power potential Vct1[i] is any one of the fixed potential Vcst and the lamp waveform and the second power potential Vct2[i] is the other, and that the one and the other take turns at every one vertical scanning period.

The display device of the second embodiment is configured identically to the display device 1 of the first embodiment, except that the first power potential Vct1[i] and the second power potential Vct2[i] generated by the potential control circuit 33 have different waveforms.

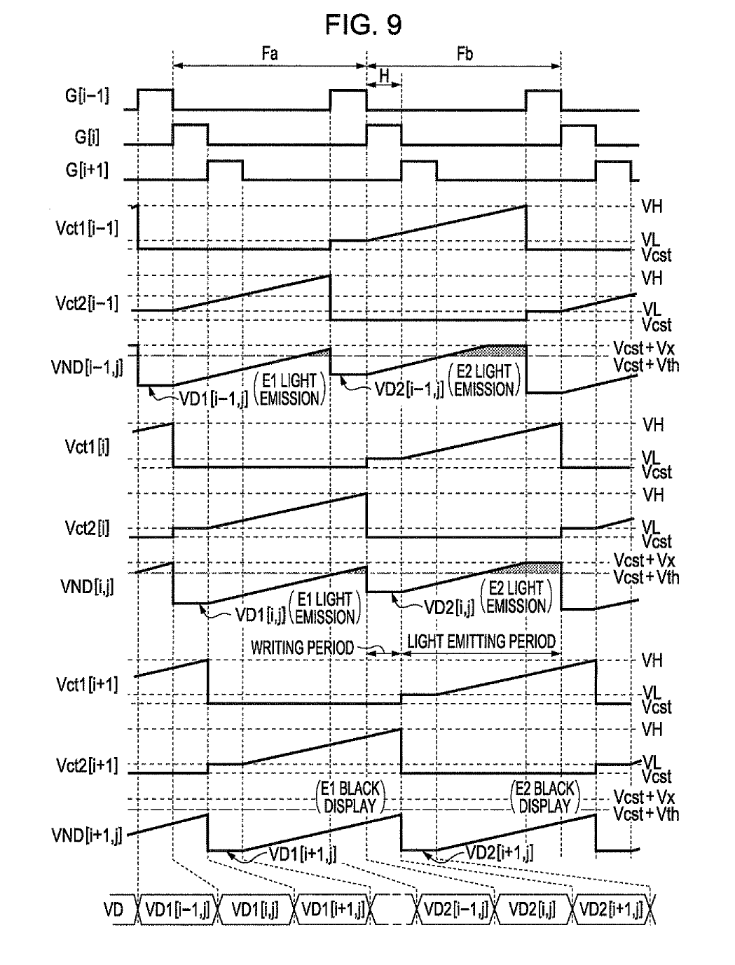

FIG. 9 is a timing chart showing the display device according to the second embodiment. As shown in FIG. 9, in odd frames Fa, the first power potential Vct1[i] is a fixed potential Vcst, and the second power potential Vct2[i] has a lamp waveform. Meanwhile, in even frames Fb, the first power potential Vct1[i] has a lamp waveform, and the second power potential Vct2[i] is a fixed potential Vcst. In addition, in the j^{th} data line, the first data potential VD1[i, j] corresponding to the first light emitting element E1 is supplied in odd frames Fa, while the second data potential VD2[i, j] corresponding to the second light emitting element E2 is supplied in even frames Fb.

By doing so, in odd frames Fa, the first light emitting element E1 may emit light, and in even frames Fb, the second light emitting element E2 may emit light. In this case, the parasitic capacitance C1 functions as a current source which supplies current to the second light emitting element E2, while the parasitic capacitance C2 functions as a current source which supplies current to the first light emitting element E1. As a result, the pixel circuit 20 may have a simple configuration having one selection transistor Tr1 and two light emitting elements, which allows the improvement of the aperture ratio.

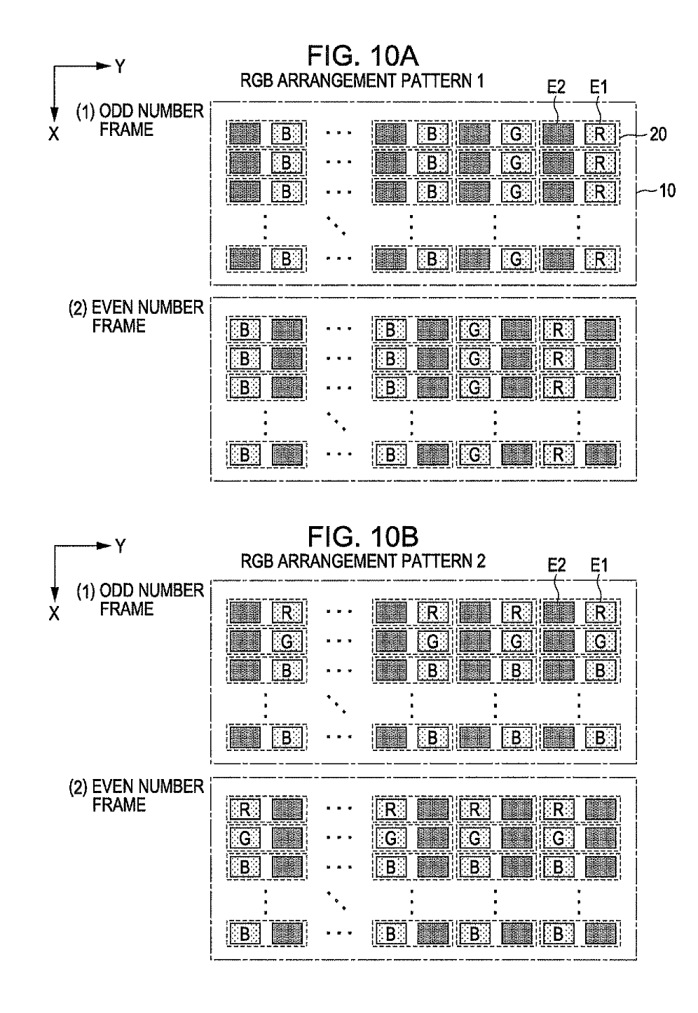

FIGS. 10A and 10B are diagrams showing light emitting patterns of the display region 10. In the display region 10, the first light emitting element E1 of the pixel circuit 20 in each column sequentially emits light at every first light emitting period TL1 based on the first data potential VD1[i, j] in odd frames, and the second light emitting element E2 of the pixel circuit 20 in each column sequentially emits light at every second light emitting period TL2 based on the second data potential VD2[i, j] in even frames.

In the example shown in FIG. 10A, N number of pixel circuits 20 emitting any one of R, G and B colors are arranged in one column in a direction extending in the X-axial direction, and the row of N number of these pixel circuits 20 emitting R, G and B colors may be disposed in a stripe shape in the Y-axial direction. In this case, in each horizontal scanning period, the data potential VD[i] supplied from the data line driving circuit 32 becomes a signal representing any one of R, G and B colors, which allows the data potential VD[i] to be easily generated.

In addition, as shown in FIG. 10B, M number of pixel circuits 20 emitting any one of R, G and B colors may be arranged in a line in a direction extending in the Y-axial direction, and the column of M number of these pixel circuits 20 emitting R, G and B colors may be disposed in a stripe shape in the X-axial direction.

As described above, in the display device according to the second embodiment, the first light emitting element E1 displays a first image based on the first data potential VD1[i, j], and the second light emitting element E2 displays a second image based on the second data potential VD2[i, j]. Therefore, a two-screen display device displaying different images in right and left regions may be implemented by separating a region where the first image may be observed and a region where the second image may be observed by means of an optic method or the like. In this case, for example, the region where the first image may be observed may be set to be located toward the right eye of an observer, and the region where the second image may be observed may be set to be located toward the left eye of the observer so that different images are observed by two eyes, which may realize a 3D display device.

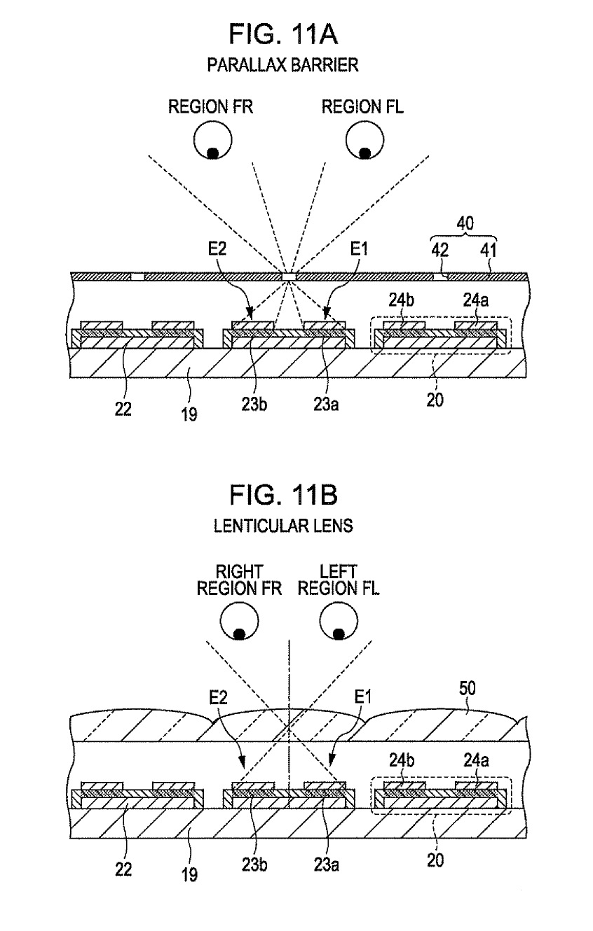

FIGS. 11A and 11B show examples of two-screen display devices which optically separate the first image displayed by the first light emitting element E1 and the second image displayed by the second light emitting element E2. FIG. 11A is a sectional view of a display device which separately displays the first image displayed by the first light emitting element E1 and the second image displayed by the second light emitting element E2 by using a parallax barrier 40. The parallax barrier 40 includes a light shielding unit 41 and an opening 42. The opening 42 is disposed between the first light emitting element E1 and the second light emitting element E2 so that, among the light emitted by the first light emitting element E1, the light oriented toward a left region FL is observed by the light shielding unit 41 and the light oriented toward a right region FR is output through the opening 42. Similarly, the light emitted by the second light emitting element E2 is output only to the left region FL through the opening 42.

In this case, the location of the parallax barrier 40 and the location and size of the opening 42 are set so that the right region FR and the left region FL are respectively located toward the right eye and the left eye of an observer, whereby the observer may observe different images in the right and left eye, thereby realizing, for example, a 3D display device.

In addition, the location of the parallax barrier 40 and the location and size of the opening 42 may be set so that the right region FR and the left region FL are respectively aligned with different locations of two observers, which may realize a two-screen display device capable of displaying different images for two observers located at both sides of the display device 1.

Further, this two-screen display device may be realized by using a lenticular lens 50 instead of the parallax barrier 40. FIG. 11B is a sectional view showing a display device which separates the first and second images by using the lenticular lens 50.

In the lenticular lens 50, each lens of the lenticular lens 50 is disposed at a center of the first light emitting element E1 and the second light emitting element E2, so that the light emitted by the first light emitting element E1 is output to the right region FR and the light emitted by the second light emitting element E2 is output to the left region FL. By doing so, a two-screen display device displaying different images in the right region FR and the left region FL can be realized.

As described above, in the second embodiment, since the first light emitting element E1 and the second light emitting element E2 selectively emit light, they may display different images, and two-screen display or 3D display may be realized by separating and guiding them to different regions. Further, since the parasitic capacitance C1 and the parasitic capacitance C2 function as current sources, the configuration of the pixel circuit 20 may be simplified.

### C: Third Embodiment

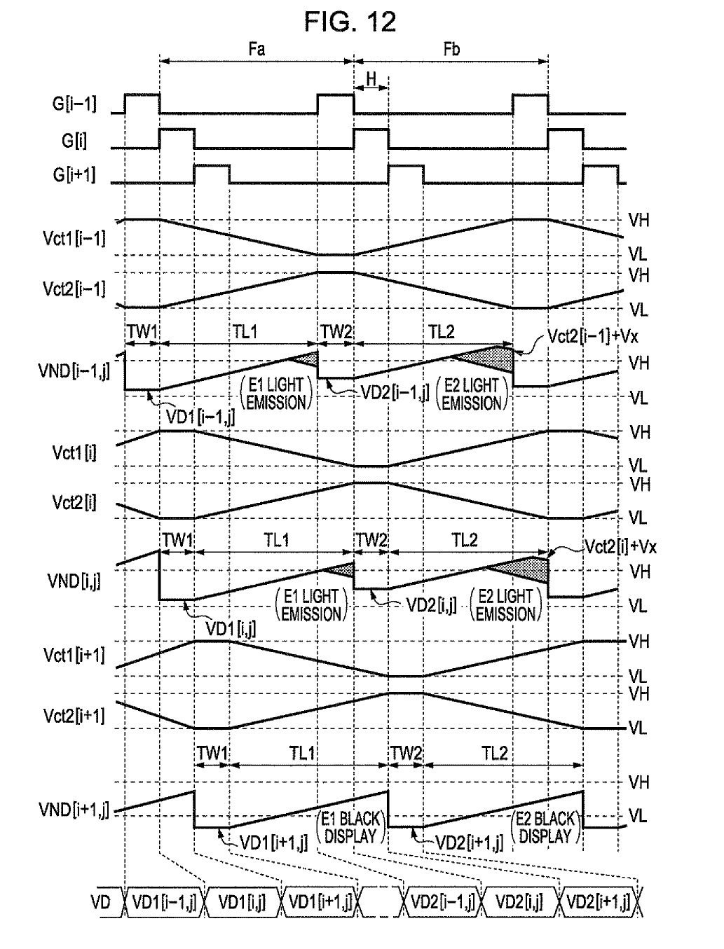

FIG. 12 is a timing chart for illustrating operations of a display device according to a third embodiment.

The display device of the third embodiment is configured identical to the display device 1 of the first embodiment, except that the first power potential Vct1[i] and the second power potential Vct2[i] generated by the potential control circuit 33 have different waveforms.

In other words, in the first embodiment, the second power potential Vct2[i] has a lamp waveform varying between the first potential VL and the second potential VH, and the first power potential Vct1[i] is maintained at the fixed potential Vcst. In this regard, in the third embodiment, the first power potential Vct1[i] and the second power potential Vct2[i] are output from the potential control circuit 33 so as to have a waveform periodically varying between the first potential VL and the second potential VH.

As shown in FIG. 12, in the period when the selection signal G[i] is at a high level, the data potential VD[i, 1] to VD[i, N] defining a tone of the pixel circuit 20 is supplied from the data line driving circuit 32 to N number of pixel circuits 20 belonging to the i column. The data potential VD[i, j] includes a first data potential VD1[i, j] defining a tone of the first light emitting element E1 of the pixel circuit 20 and a second data potential VD2[i, j] defining a tone of the second light emitting element E2.

In addition, in the third embodiment, among the region when the selection signal G[i] is at a high level, in odd frames Fa, the period when the first data potential VD1[i, j] is supplied is defined as a first writing period TW1, and, after the first writing period TW1, the period when the selection signal G[i] is at a low level is defined as a first light emitting period TL1. In addition, among the period when the selection signal G[i] is at a high level, in even frames Fb, the period when the second data potential VD2[i, j] is supplied is defined as a second writing period TW2, and after the second writing period TW2, the period when the selection signal G[i] is at a low level is defined as a second light emitting period TL2. The first light emitting period TL1 and the second light emitting period TL2 are installed in turns at every one vertical scanning period.

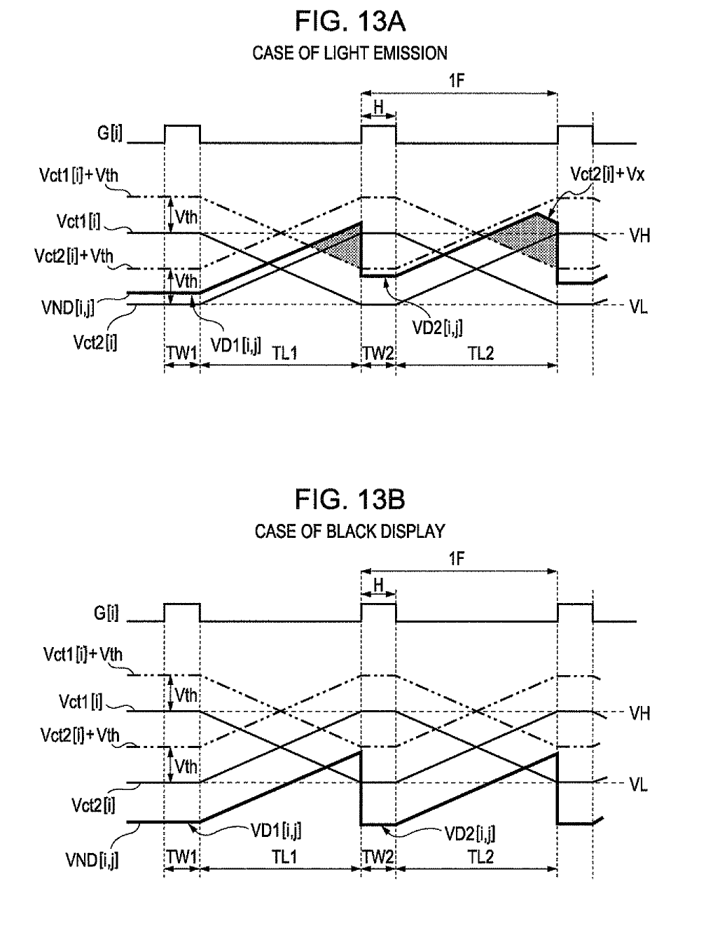

FIGS. 13A and 13B are diagrams in which the first power potential Vct1[i], the second power potential Vct2[i], the first data potential VD1[i, j], the second data potential VD2[i, j], and the potential VND[i, j] of the node ND supplied to the pixel circuit 20 in the i column and the j row in FIG. 12 are schematically plotted on the same gradations in the Y-axial direction.

As shown in FIGS. 12 to 13B, in the third embodiment, the first power potential Vct1[i] and the second power potential Vct2[i] have a period corresponding to two vertical scanning periods.

The first power potential Vct1[i] is set to the second potential VH in the first writing period TW1, and linearly changes with a constant gradient from the second potential VH to the first potential VL in the first light emitting period TL1. In addition, in the second writing period TW2, the first power potential Vct1[i] is set to the first potential VL, and linearly changes with a constant gradient from the first potential VL to the second potential VH in the second light emitting period TL2.

The second power potential Vct2[i] is set to the first potential VL in the first writing period TW1, and linear changes with a constant gradient from the first potential VL to the second potential VH in the first light emitting period TL1. In addition, the second power potential Vct2[i] is set to the second potential VH in the second writing period TW2, and linear changes with a constant gradient from the second potential VH to the first potential VL in the second light emitting period TL2.

In the first light emitting period TL1, as the second power potential Vct2[i] increases with a constant gradient, the potential VND[i, j] of the node ND also increases. In addition, if the potential VND[i, j] of the node ND reaches a potential higher than the first power potential Vct1[i] by the light-emitting threshold voltage Vth, the first light emitting element E1 emits light.

In the second light emitting period TL2, as the first power potential Vct1[i] increases with a constant gradient, the potential VND[i, j] of the node ND also increases. In addition, if the potential VND[i, j] of the node ND reaches a potential higher than the second power potential Vct2[i] by the light-emitting threshold voltage Vth, the second light emitting element E2 emits light.

If the potential VND[i, j] of the node ND reaches a potential higher than a lower one of the first power potential Vct1[i] and the second power potential Vct2[i] by the operation voltage Vx, then, until the selection signal G[i] increases to a high level, the potential VND[i, j] of the node ND changes while being a potential higher than a lower one of the first power potential Vct1[i] and the second power potential Vct2[i] by the operation voltage Vx.

In other words, in the first light emitting period TL1, if the potential VND[i, j] of the node ND reaches a potential higher than the first power potential Vct1[i] by the operation voltage Vx, then, until the selection signal G[i] increases to a high level, the potential VND[i, j] decreases with the same slant as the first power potential Vct1[i]. Similarly, in the second light emitting period TL2, if the potential VND[i, j] of the node ND reaches a potential higher than the second power potential Vct2[i] by the operation voltage Vx, then, until the selection signal G[i] increases to a high level, the potential VND[i, j] decreases with the same slant as the second power potential Vct2[i].

The potential VND[i, j] of the node ND is set to the first data potential VD1[i, j] in the first writing period TW1 of an odd frame Fa, and set to the second data potential VD2[i, j] in the second writing period TW2 of an even frame Fb. The data potential VD[i, j] is set to satisfy Equations (8) and (9) as follows.

VD[i,j]−VL<Vth (8)

(VD[i,j]+VH−VL)−VL≧Vth (9)

Equation (8) represents that the potential difference between the data potential VD[i, j] and the first voltage VL is less than the light-emitting threshold voltage Vth.

In the first writing period TW1 and the second writing period, the potential VND[i, j] of the node ND is set to the data potential VD[i, j], and a lower one of the first power potential Vct1[i] and the second power potential Vct2[i] is identical to the first potential VL. Therefore, in the case where Equation (8) is satisfied, the first light emitting element E1 and the second light emitting element E2 are not capable of emitting light.

In the first light emitting period TL1, the potential VND[i, j] of the node ND increases along with the increase of the second power potential Vct2[i]. Therefore, in the first light emitting period TL1, the second light emitting element E2 does not emit light.

Similarly, in the second light emitting period TL2, the potential VND[i, j] of the node ND increases along with the increase of the first power potential Vct1[i]. Therefore, in the second light emitting period TL2, the first light emitting element E1 does not emit light.

Equation (9) represents that the potential difference between the first potential VL and the potential obtained by adding the difference between the second potential VH and the first potential VL to the data potential VD[i, j] is equal to or greater than the light-emitting threshold voltage Vth.

In the first light emitting period TL1, the second power potential Vct2[i] increases from the first potential VL to the second potential VH by the potential difference VH−VL. In the case where the first light emitting element E1 and the second light emitting element E2 do not emit light together, the potential VND[i, j] of the node ND as increases with a constant gradient to a potential higher than the first data potential VD1[i, j] by the potential difference VH−VL along with the increase of the second power potential Vct2[i]. Meanwhile, the first power potential Vct1[i] decreases with a constant gradient from the second potential VH to the first potential VL. Therefore, in the case where the potential difference (VD1[i, j]+VH−VL)−VL between the potential VND[i, j] of the node ND and the first power potential Vct1[i] is the light-emitting threshold voltage Vth or above, the first light emitting element E1 emits light.

Similarly, in the second light emitting period TL2, the first power potential Vct1[i] increases from the first potential VL to the second potential VH by the potential difference VH−VL. In the case where the first light emitting element E1 and the second light emitting element E2 do not emit light together, the potential VND[i, j] of the node ND also increases with a constant gradient to a potential higher than the second data potential VD2[i, j] by the potential difference VH−VL along with the increase of the first power potential Vct1[i]. Meanwhile, the second power potential Vct2[i] decreases with a constant gradient from the second potential VH to the first potential VL. Therefore, in the case where the potential difference (VD2[i, j]+VH−VL)−VL between the potential VND[i, j] of the node ND and the second power potential Vct2[i] is equal to or greater than the light-emitting threshold voltage Vth, the second light emitting element E2 emits light.

In addition, in the case where the pixel circuit 20 is set to black display, namely in the case where the first light emitting element E1 (and the second light emitting element E2) does not emit light, the condition is that Equation (9) is not satisfied. In other words, therefore, if the data potential VD[i, j] satisfying Equation (10) as follows is supplied, the corresponding pixel circuit 20 may be able to set black display.

(VD[i,j]+VH−VL)−VL<Vth (10)

FIG. 13B shows the first power potential Vct1[i], the second power potential Vct2[i], the first data potential VD1[i, j], the second data potential. VD2[i, j], and the potential VND[i, j] of the node ND, which satisfy Equation (10).

As shown in FIG. 13B, in the case where the data potential VD[i, j] satisfying Equation (10) is set as the potential VND[i, j] of the node ND, then, in the first light emitting period TL1 or the second light emitting period TL2, the potential VND[i, j] of the node ND will not be a potential higher than a lower one of the first power potential Vct1[i] and the second power potential Vct2[i] by the light-emitting threshold voltage Vth or more. Therefore, in this case, the first light emitting element and the second light emitting element are not capable of emitting light.

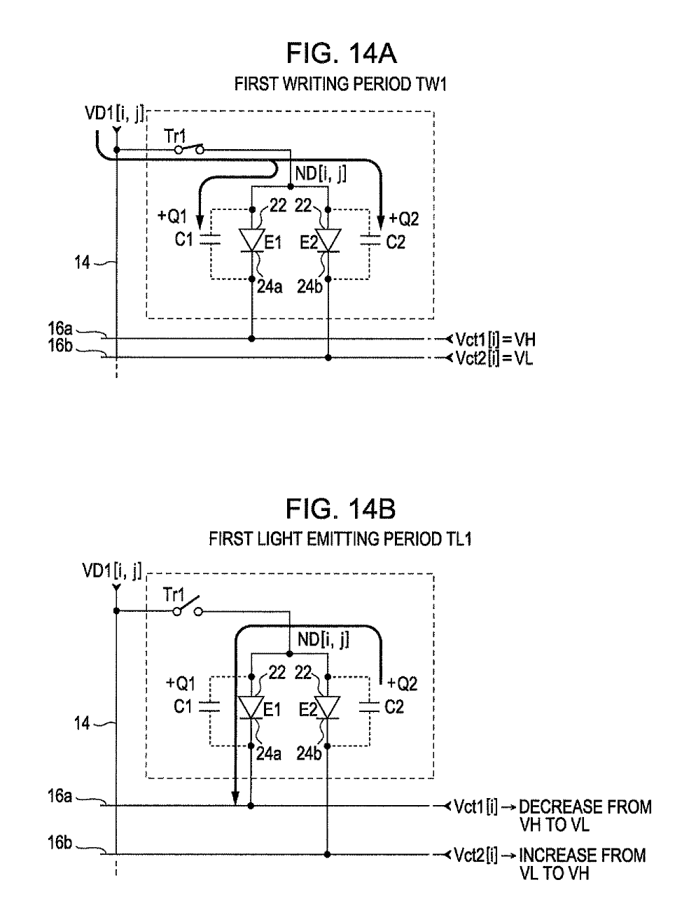

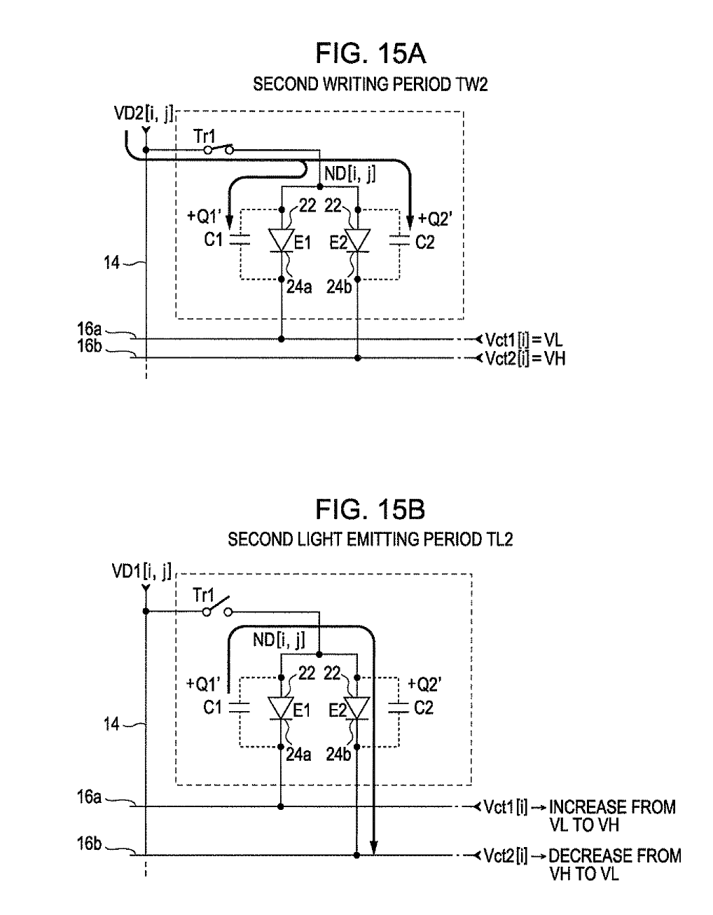

The operations of the pixel circuit 20 in the i column and the j row will be described with reference to FIGS. 14A to 15B. FIG. 14A is a diagram showing operations of the pixel circuit 20 in the first writing period TW1. In the first writing period TW1, the selection signal G[i] is at a high level, and the selection transistor Tr1 turns on. The first data potential VD1[i, j] is supplied via the node ND to the parasitic capacitance C1 and the parasitic capacitance C2 from the data line 14. By doing so, the potential VND[i, j] of the node ND is set to the first data potential VD1[i, j], and charge Q1 and Q2 corresponding to the first data potential VD1[i, j] is respectively supplied to the parasitic capacitance C1 and the parasitic capacitance C2. In addition, the first data potential VD1[i, j] is set to satisfy Equations (8) and (9).

The first power potential Vct1[i] is set to the second potential VH. In Equation (8), the potential difference between both electrodes of the first light emitting element E1 is less than the light-emitting threshold voltage Vth, and the first light emitting element E1 does not emit light. In addition, the second power potential Vct2[i] is set to the first potential VL. In Equation (8), the potential difference between both electrodes of the second light emitting element E2 is less than the light-emitting threshold voltage Vth, and the second light emitting element E2 does not emit light.

FIG. 14B is a diagram showing operations of the pixel circuit 20 in the first light emitting period TL1 after the period of FIG. 14A. In the first light emitting period TL1, since the selection signal G[i] is at a low level, the selection transistor Tr1 turns off, and the data line 14 and the first node ND are not connected.

The second power potential Vct2[i] increases with a constant gradient from the first potential VL to the second potential VH. Along with this, the potential VND[i, j] of the node ND increases. Meanwhile, the first power potential Vct1[i] decreases with a constant gradient from the second potential VH to the first potential VL. In addition, in the case where Equation (9) is satisfied, when the potential difference VND[i, j]−Vct1[i] between both electrodes of the first light emitting element E1 is equal to or greater than the light-emitting threshold voltage Vth, the first light emitting element E1 emits light.

FIG. 15A is a diagram showing operations of the pixel circuit 20 in the second writing period TW2 after the period of FIG. 14B. In the second writing period TW2, similar to the first writing period, the selection signal G[i] comes to a high level, and the second data potential VD2[i, j] is supplied via the node ND to the parasitic capacitance C1 and the parasitic capacitance C2 from the data line 14. By doing so, the potential VND[i, j] of the node ND is set to the second data potential VD2[i, j], and charge Q1′ and Q2′ corresponding to the second data potential VD2[i, j] is respectively supplied to the parasitic capacitance C1 and the parasitic capacitance C2. In addition, the second data potential VD2[i, j] is set to satisfy Equations (8) and (9).

The first power potential Vct1[i] is set to the first potential VL. In Equation (8), the potential difference between both electrodes of the first light emitting element E1 is less than the light-emitting threshold voltage Vth, and therefore the first light emitting element E1 does not emit light. In addition, the second power potential Vct2[i] is set to the second potential VH. In Equation (8), the potential difference between both electrodes of the second light emitting element E2 is less than the light-emitting threshold voltage Vth, and therefore the second light emitting element E2 does not emit light.

FIG. 15B is a diagram showing operations of the pixel circuit 20 in the second light emitting period TL2 after the period of FIG. 15A. In the second light emitting period TL2, the selection signal G[i] is at a low level, and therefore the data line 14 and the first node ND are not connected.

The first power potential Vct1[i] increases with a constant gradient from the first potential VL to the second potential VH. Along with it, the potential VND[i, j] of the node ND increases. Meanwhile, the second power potential Vct2[i] decreases with a constant gradient from the second potential VH to the first potential VL. In addition, in the case where Equation (9) is satisfied, when the potential difference VND[i, j]−Vct2[i] between both electrodes of the second light emitting element E2 is equal to or greater than the light-emitting threshold voltage Vth, the second light emitting element E2 emits light.

As described above, in the third embodiment, the first power potential Vct1[i] and the second power potential Vct2[i] are differentially driven, and therefore the dynamic ranges of the first power potential Vct1[i] and the second power potential Vct2[i] may be suppressed in half in comparison to the first embodiment. Therefore, the display device of the third embodiment has an advantage in terms of low power consumption.

### D: Modified Examples

The invention is not limited to the above embodiments but may be modified as follows for example.

### (1) Modified Example 1

In the first, second and third embodiments described above, the first opposite electrode 24a is electrically connected to the potential control circuit 33 via the first power line 16a, and the second opposite electrode 24b is electrically connected to the potential control circuit 33 via the second power line 16b, but the invention is not limited thereto.

In other words, the first power line 16a may be partially or entirely configured by the first opposite electrode 24a. In addition, the second power line 16b may be partially or entirely configured by the second opposite electrode 24b.

In the case where the first power line 16a is entirely configured by the first opposite electrode 24a and the second power line 16b is entirely configured by the second opposite electrode 24b, the first opposite electrode 24a and the second opposite electrode 24b are directly connected to the potential control circuit 33.

In this case, in the display region 10, it is not necessary to form 2M number of power lines, and therefore the yield may be improved by simplified production processes.

### (2) Modified Example 2

In the first, second and third embodiments described above, the first light emitting element E1 and the second light emitting element E2 are disposed to be arranged in the Y-axial direction in each pixel circuit 20, but the invention is not limited thereto.

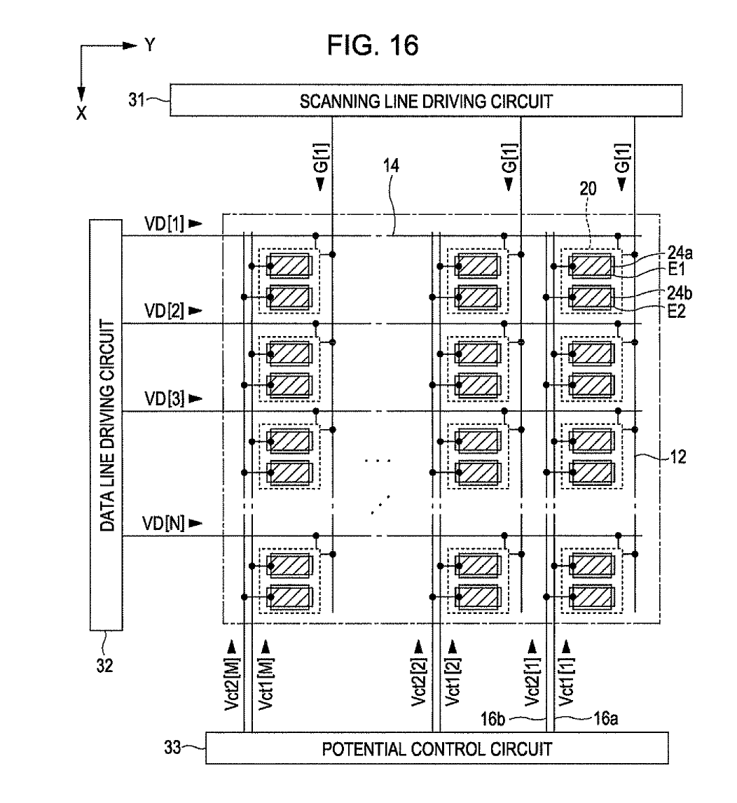

In other words, as shown in FIG. 16, in each pixel circuit 20, the first light emitting element E1 and the second light emitting element E2 may be disposed to be arranged in the X-axial direction.

In this case, the first opposite electrode 24a and the second opposite electrode 24b are individually formed in each pixel circuit 20. In addition, M number of first power lines 16a are disposed to make pairs with M number of scanning lines 12 so as to be connected to N number of first opposite electrodes 24a provided to N number of pixel circuits 20 connected to the same scanning line 12. Similarly, M number of second power lines 16b are disposed to make pairs with M number of scanning lines 12 so as to be connected to N number of second opposite electrodes 24b provided to N number of pixel circuits 20 connected to the same scanning line 12.

### (3) Modified Example 3

In the first, second and third embodiments described above, in the light emitting period (the first light emitting period and the second light emitting period), the first power potential Vct1[i] or the second power potential Vct2[i] has a lamp waveform, but the invention is not limited thereto. Essentially, any waveform may be used if current flows from the parasitic capacitance incidental to a light emitting element which does not emit light to a light emitting element which emits light so that the corresponding light emitting element emits light. For example, a waveform uniformly increasing from the first potential VL to the second potential VH (which is applied to the first and second embodiments) may be used, and a waveform uniformly decreasing from the second potential VH to the first potential VL (which is applied to the third embodiment) may also be used.

### E: Application Example

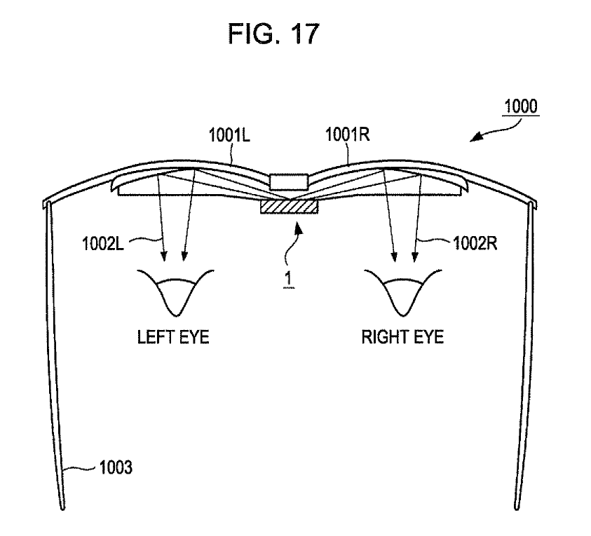

Next, an electronic device using the display device 1 according to each embodiment will be described. FIGS. 17 to 19 show electronic devices adopting the display device 1.

FIG. 17 is a sectional view showing a configuration of a HMD (Head Mounted Display) 1000 adopting the display device 1. The HMD 1000 includes the display device 1 for displaying a first image 1002L and a second image 1002R, a light guide plate 1001L for guiding the first image 1002L toward the left eye of an observer, a light guide plate 1001R for guiding the second image 1002R to the right eye of the observer, and a frame 1003. The HMD 1000 may also be utilized as a 3D display device.

The HMD 1000 adopting the display device 1 displays the first image 1002L and the second image 1002R with one display device 1, not using different display devices, and therefore the HMD 1000 may be designed so as to be smaller and lighter.

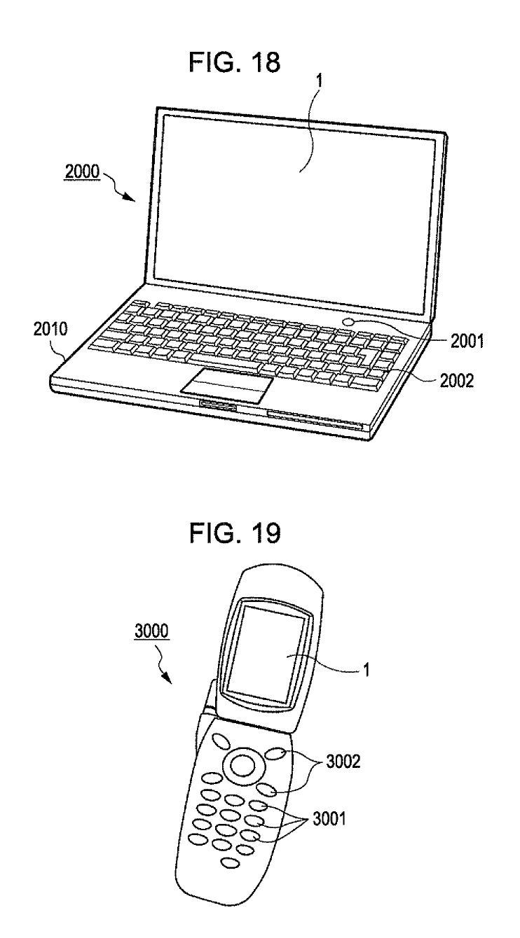

FIG. 18 is a perspective view showing the configuration of a mobile-type personal computer adopting the display device 1. The personal computer 2000 includes the display device 1 for displaying various images and a body portion 2010 to which a power switch 2001 and a keyboard 2002 are installed.

FIG. 19 is a perspective view showing the configuration of a cellular phone adopting the display device 1. The cellular phone 3000 includes a plurality of manipulation buttons 3001, scroll buttons 3002, and the display device 1 for displaying various images. The screen of the display device 1 is scrolled by manipulating the scroll buttons 3002.

In addition, the electronic devices to which the light emitting device according to the invention is applied may be digital cameras, televisions, video cameras, car navigation systems, wireless pagers, electronic notebooks, electronic paper, calculators, word processors, work stations, video telephones, POS terminals, printers, scanners, copy machines, video players, devices with a touch panel, and so on, in addition to the devices shown in FIGS. 17 to 19.

This application claims priority from Japanese Patent Application No. 2010-238532 filed in the Japanese Patent Office on Oct. 25, 2010, the entire disclosure of which is hereby incorporated by reference in its entirely.

What is claimed is:

1. A pixel circuit comprising:
a switching element having one terminal supplied with a writing voltage and the other terminal electrically connected to a node so that the switching element turns on in a writing period and turns off in a light emitting period;
a first light emitting element having one electrode electrically connected to the node and the other electrode electrically connected to a first power line;
a second light emitting element having one electrode electrically connected to the node and the other electrode electrically connected to a second power line;
a first capacitor installed in parallel with the first light emitting element; and
a second capacitor installed in parallel with the second light emitting element,
wherein, in the writing period, a writing voltage is applied to the first capacitor and the second capacitor to accumulate charge, and
wherein, in the light emitting period, current flows from any one of the first capacitor and the second capacitor to the light emitting element installed in parallel with the other capacitor so that the corresponding light emitting element emits light by the corresponding current.

2. The pixel circuit according to claim 1,
wherein the first capacitor is partially or entirely a parasitic capacitance of the first light emitting element, and
wherein the second capacitor is partially or entirely a parasitic capacitance of the second light emitting element.

3. A method for driving a pixel circuit, the pixel circuit being specified in claim 1, comprising:
in the writing period,
supplying a potential where a voltage applied to the first light emitting element is less than a light-emitting threshold voltage to the first power line; and
supplying a potential in which a voltage applied to the second light emitting element is less than the light-emitting threshold voltage to the second power line.

4. The method for driving the pixel circuit according to claim 3,
wherein, in the writing period, a voltage according to brightness of the first light emitting element is written as the writing voltage, and
wherein, in the light emitting period, a fixed potential is supplied to the first power line, and the potential of the second power line is changed to flow current from the second capacitor to the first light emitting element.

5. The method for driving the pixel circuit according to claim 3,
wherein, in the case where a voltage according to brightness of the first light emitting element is written as the writing voltage in the writing period, in the light emitting period, a fixed potential is supplied to the first power line, and the potential of the second power line is changed to flow current from the second capacitor to the first light emitting element, and
wherein, in the case where a voltage according to brightness of the second light emitting element is written as the writing voltage in the writing period, in the light emitting period, a fixed potential is supplied to the second power line, and the potential of the first power line is changed to flow current from the first capacitor to the second light emitting element.

6. The method for driving the pixel circuit according to claim 3,
wherein, in the case where a voltage according to brightness of the first emitting element is written as the writing voltage in the writing period, in the light emitting period, the potentials of the first power line and the second power line are changed so that current flows from the second capacitor to the first light emitting element, and
wherein, in the case where a voltage according to brightness of the second light emitting element is written as the writing voltage in the writing period, in the light emitting period, the potentials of the first power line and the second power line are changed so that current flows from the first capacitor to the second light emitting element.

7. An electro-optical apparatus comprising:
a plurality of scanning lines;
a plurality of data lines;
a plurality of first power lines;
a plurality of second power lines;
a pixel circuit respectively installed corresponding to intersections between the plurality of scanning lines and the plurality of data lines and having a switching element installed between the data line and a node to turn on by a selection signal, a first light emitting element having one electrode electrically connected to the node and the other electrode electrically connected to the first power line, a second light emitting element having one electrode electrically connected to the node and the other electrode electrically connected to the second power line, a first capacitor installed in parallel with the first light emitting element, and a second capacitor installed in parallel with the second light emitting element;
a scanning line driving circuit for sequentially exclusively outputting the selection signal to the plurality of scanning lines;
a data line driving circuit for supplying a writing voltage via the plurality of data lines to the plurality of pixel circuits installed corresponding to the scanning line selected by the selection signal; and
a potential control circuit for supplying potentials to the plurality of first power lines and the plurality of second power lines,
wherein, assuming that, with respect to each of the plurality of pixel circuits, a period when the selection signal is supplied is a writing period and a period when the selection signal is not supplied is a light emitting period,
the potential control circuit performs:
supplying a potential in which a voltage applied to the first light emitting element is less than a light-emitting threshold voltage, to the first power line connected to the pixel circuit in the writing period;
supplying a potential in which a voltage applied to the second light emitting element is less than the light-emitting threshold voltage, to the second power line connected to the pixel circuit in the writing period; and
setting potentials supplied to the fist power line and the second power line connected to the pixel circuit in the light emitting period so that current flows from any one of the first capacitor and the second capacitor to a light emitting element installed in parallel with the other capacitor.

8. The electro-optical apparatus according to claim 7,
wherein, by the potential control circuit,
with respect to the pixel circuit in which a voltage according to brightness of the first light emitting element is written as the writing voltage in the writing period, in the light emitting period, a fixed potential is supplied to the first power line corresponding to the respective pixel circuit, and the potential of the second power line corresponding to the respective pixel circuit is changed to flow current from the second capacitor to the first light emitting element, and
with respect to the pixel circuit in which a voltage according to brightness of the second light emitting element is written as the writing voltage in the writing period, in the light emitting period, a fixed potential is supplied to the second power line, and the potential of the first power line is changed to flow current from the first capacitor to the second light emitting element.

9. The electro-optical apparatus according to claim 7,
wherein, with respect to the pixel circuit in which a voltage according to brightness of the first light emitting element is written as the writing voltage in the writing period, in the light emitting period, the potentials of the first power line and the second power line corresponding to the respective pixel circuit are changed so that current flows from the second capacitor to the first light emitting element, and
with respect to the pixel circuit in which a voltage according to brightness of the second light emitting element is written as the writing voltage in the writing period, in the light emitting period, the potentials of the first power line and the second power line corresponding to the respective pixel circuit are changed so that current flows from the first capacitor to the second light emitting element.

10. An electronic device having the electro-optical apparatus according to claim 7.

11. An electronic device having the electro-optical apparatus according to claim 8.

12. An electronic device having the electro-optical apparatus according to claim 9.
